(19) United States
(12) Patent Application Publication
(10) Pub. No.: US 2015/0098396 A1
(43) Pub. Date: Apr. 9, 2015

(54) METHOD AND WIRELESS DEVICE FOR CONTROLLING CHANNELS

(71) Applicant: Kabushiki Kaisha Toshiba, Tokyo (JP)

(72) Inventor: Shinya Yamamoto, Hino-shi (JP)

(21) Appl. No.: 14/330,863

(22) Filed: Jul. 14, 2014

Related U.S. Application Data
(60) Provisional application No. 61/887,872, filed on Oct. 7, 2013.

(51) Int. Cl. H04W 16/14

(52) U.S. Cl. CPC H04W 16/14; H04W 48/16
USPC 370/329

(57) ABSTRACT

According to one embodiment, a method inquires one or more first nodes of another wireless communication scheme, which are present in a nearby area of a neighboring wireless device of a wireless device, about use channels, thereby obtaining first information indicative of one or more channels of the another wireless communication scheme which are being used in the nearby area of the neighboring wireless device. The method further sets, based on the first information, a channel of the first wireless communication scheme, which is to be used for transmitting data from the wireless device to the neighboring wireless device, to be a first channel which does not overlap a frequency range corresponding to the one or more channels.

### CROSS-REFERENCE TO RELATED APPLICATIONS

This application claims the benefit of U.S. Provisional Application No. 61/887,872, filed Oct. 7, 2013, the entire contents of which are incorporated herein by reference.

### FIELD

Embodiments described herein relate generally to a technique for avoiding interference between wireless systems.

### BACKGROUND

In recent years, the Industrial, Scientific and Medical (ISM) band of 2.4 GHz has been used in various wireless communication schemes. An example of the wireless communication scheme using the ISM band is wireless LAN.

ZigBee™ is also a wireless communication scheme using the ISM band of 2.4 GHz. ZigBee™ is known as a wireless communication scheme which is suited to construction of a sensor network. Hereafter, it is expected that various electronic devices with wireless communication functions supporting the ZigBee™ standard, for example, home area network (HAN) devices such as smart meters, will gain in popularity.

However, in the vicinity of a ZigBee device using the 2.4 GHz band, if a wireless LAN device using the same 2.4 GHz band is present, there is a case in which interference called co-channel occurs.

Thus, a new technique for suppressing the occurrence of co-channel interference is required.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a view illustrating a structure example of a wireless system including a wireless device according to an embodiment.

FIG. 2 is an exemplary view for explaining an information exchange process which is executed between a wireless device of the embodiment and a neighboring wireless device of this wireless device.

FIG. 3 is an exemplary view for explaining a relationship between channel allocation, which is used in a wireless communication scheme corresponding to the wireless device of the embodiment, and channel allocation which is used in another wireless communication system.

FIG. 4 is an exemplary view for explaining a permission signal transmission process which is executed by the wireless device of the embodiment.

FIG. 5 is an exemplary view for explaining a data transmission process which is executed by a wireless system including the wireless device of the embodiment.

FIG. 6 is a block diagram illustrating a structure example of the wireless device of the embodiment.

FIG. 7 is an exemplary flowchart for describing the outline of an operational procedure of the wireless system including the wireless device of the embodiment.

FIG. 8 is an exemplary flowchart for describing the procedure of a channel determination process which is executed by the wireless system including the wireless device of the embodiment.

### DETAILED DESCRIPTION

Various embodiments will be described hereinafter with reference to the accompanying drawings.

In general, according to one embodiment, a wireless device executes wireless communication according to a first wireless communication scheme. The wireless device includes a transceiver and a controller. The transceiver wirelessly transmits and receives a signal. The controller sets a channel of the first wireless communication scheme, which is to be used for transmission of data from the transceiver to a neighboring wireless device of the wireless device, to be a first channel. The first channel is determined in accordance with first information indicative of one or more channels of another wireless communication scheme, which are being used in a nearby area of the neighboring wireless device. The first channel does not overlap a frequency range corresponding to the one or more channels. The first information is obtained by a process of inquiring one or more first nodes of the another wireless communication scheme, which are present in the nearby area of the neighboring wireless device, about use channels. The process of inquiring is executed by the neighboring wireless device.

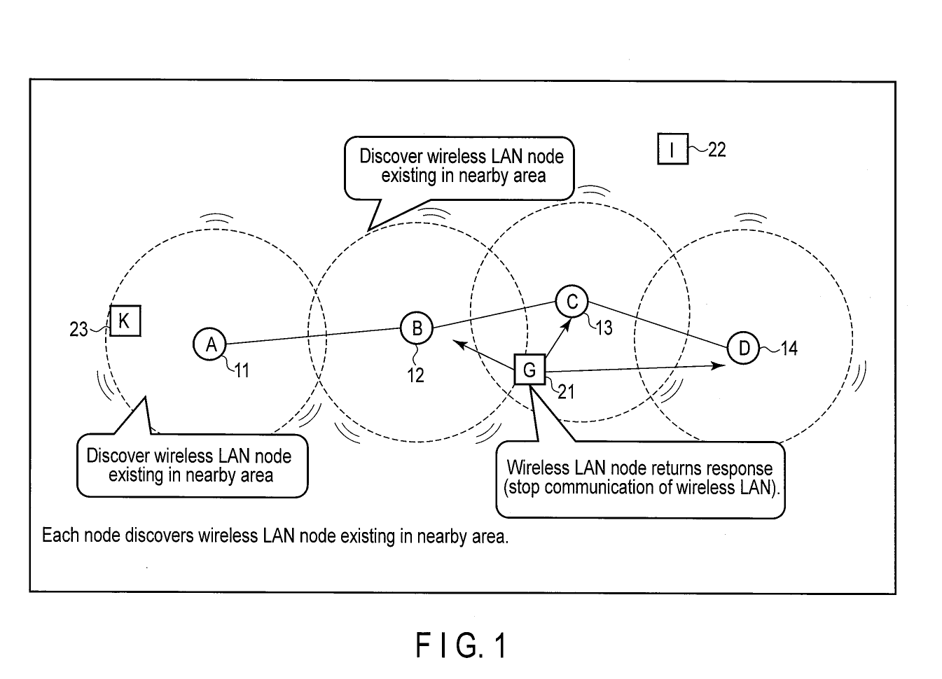

FIG. 1 illustrates a structure example of a wireless system including a wireless device according to an embodiment. This wireless device is configured to execute wireless communication according to a wireless communication scheme which is used in a frequency band such as a 2.4 GHz band. The case is now assumed that this wireless communication scheme is ZigBee™. ZigBee™ is a wireless communication scheme using the wireless standard of IEEE 802.15.4.

As described above, the 2.4 GHz band is also used by wireless LAN (IEEE 802.11b/g/n). Thus, if a wireless LAN node is present near a wireless system which supports ZigBee™, there is a case in which interference called co-channel interference occurs. This being the case, in the present embodiment, each of devices of the ZigBee™ wireless system acquires information indicative of wireless LAN channels which are being used by nearby wireless LAN nodes by communication (negotiation) with the nearby wireless LAN nodes. Then, mutually neighboring wireless devices exchange the information of wireless LAN channels and determine an optimal channel (ZigBee™ channel) which is to be used for wireless transmission or wireless reception of data between these devices.

A description is now given of a ZigBee™ channel which is to be used for wirelessly transmitting data from a first wireless device to a neighboring wireless device of this first wireless device.

The ZigBee™ channel, which is to be used for wirelessly transmitting data from the first wireless device (source) to the neighboring wireless device (destination) of this first wireless device, is set to be a channel (first channel) which does not overlap a frequency range corresponding to one or more wireless LAN channels that are being used in a nearby area of the neighboring wireless device. Thereby, the neighboring wireless device can normally receive data from the first wireless device, without being affected by the nearby wireless LAN channel.

The first channel is determined in accordance with first information indicative of one or more wireless LAN channels which are being used in the nearby area of the neighboring wireless device. This first information is obtained by a discovery process which is executed by the neighboring wireless device. This discovery process is a process of inquiring of one or more wireless LAN nodes, which are present in the nearby area of the neighboring wireless device, about use channels. In other words, this discovery process is a process of discovering all wireless LAN nodes, which are present in the nearby area of the neighboring wireless device, and acquiring, from the discovered wireless LAN nodes, information relating to wireless LAN channels which are being used by these wireless LAN nodes.

The first wireless device may receive, for example, first information from the neighboring wireless device. Further, the first wireless device may determine the above-described first channel, based on the first information. In this case, the first wireless device may notify the neighboring wireless device that the first channel is to be used in order to receive data from the first wireless device.

Alternatively, the neighboring wireless device may determine the above-described first channel, based on the first information. In this case, the neighboring wireless device may notify the first wireless device that the first channel is to be used in order to transmit data to the neighboring wireless device.

In this manner, in the present embodiment, the information indicative of wireless LAN channels, which are being used in the nearby area of the neighboring wireless device, is previously generated by the communication between the neighboring wireless device and wireless LAN nodes. Then, the ZigBee™ channel, which does not overlap the wireless LAN channels that are being used in the nearby area of the neighboring wireless device, is determined to be the channel which is to be used for wirelessly transmitting data from the first wireless device to the neighboring wireless device. Thus, it is possible to establish a network path using the optimal ZigBee™ channel which does not overlap the wireless LAN channels that are being used in the nearby area of the neighboring wireless device.

In the meantime, in the ZigBee™ standard, a frequency agility function is specified. This frequency agility function is a function of changing a channel that is to be used, when the communication quality has deteriorated due to interference. However, there is a case in which each time an operation for changing the channel has been executed, data communication between ZigBee devices is stopped. In addition, there is a case in which a data communication error occurs due to interference.

It is thus desirable that the occurrence of co-channel interference be suppressed, without executing an operation for a channel change as much as possible. In the present embodiment, since it is possible to establish a network path using the ZigBee™ channel which does not overlap the wireless LAN channels that are being used in the nearby area of the neighboring wireless device, the probability of occurrence of co-channel interference can be decreased.

Next, a description is given of the channel (ZigBee™ channel) which is to be used in order to wirelessly transmit data from the neighboring wireless device to the first wireless device.

The channel, which is to be used for wirelessly transmitting data from the neighboring wireless device (source) to the first wireless device (destination), is set to be a channel (second channel) which does not overlap a frequency range corresponding to one or more wireless LAN channels that are used in the nearby area of the first wireless device (destination). As a result, the first wireless device can normally wirelessly receive data from the neighboring wireless device, without being affected by the nearby wireless LAN channel.

If the condition of use of wireless LAN in the vicinity of the neighboring wireless device is the same as the condition of use of wireless LAN in the vicinity of the first wireless device, there is a case in which the second channel becomes the same as the above-described first channel. However, when the condition of use of wireless LAN in the vicinity of the neighboring wireless device is different from the condition of use of wireless LAN in the vicinity of the first wireless device, there is a case in which the second channel is different from the above-described first channel.

The second channel is determined in accordance with second information indicative of one or more wireless LAN channels which are being used in the nearby area of the first wireless device (destination). This second information is obtained by a discovery process which is executed by the first wireless device. This discovery process is a process of inquiring of one or more wireless LAN nodes, which are present in the nearby area of the first wireless device, about use channels.

The neighboring wireless device may receive, for example, the second information from the first wireless device, and may further determine the above-described second channel, based on the second information. In this case, the neighboring wireless device may notify the first wireless device that the second channel is to be used in order to receive data from the neighboring wireless device.

Alternatively, the first wireless device may determine the above-described second channel, based on the second information. In this case, the first wireless device may notify the neighboring wireless device that the second channel is to be used in order to transmit data to the first wireless device.

Next, the operation of the wireless system illustrated in FIG. 1 is described.

A wireless device (A) 11, a wireless device (B) 12, a wireless device (C) 13 and a wireless device (D) 14 are devices (ZigBee™ nodes) which are configured to execute wireless communication according to the ZigBee™ wireless communication scheme which is used in the 2.4 GHz band. These wireless devices are realized as electronic devices with ZigBee™ wireless communication functions. An example of the electronic devices with ZigBee™ wireless communication functions is a sensor device (smart meter) with a ZigBee™ wireless communication function.

A node (G) 21, a node (I) 22 and a node (K) 23 are wireless LAN nodes. These wireless LAN nodes execute wireless communication according to a wireless communication scheme of IEEE 802.11b/g/n which is used in the 2.4 GHz band. Each of the node (G) 21, node (I) 22 and node (K) 23 may be configured to support both the wireless communication scheme of wireless LAN and the wireless communication function of ZigBee™. In this case, each ZigBee™ node may execute the discovery process for discovering nearby wireless LAN nodes by using the wireless communication scheme of ZigBee™.

In FIG. 1, the case is assumed that a network path that is to be established includes the wireless device (A) 11, wireless device (B) 12, wireless device (C) 13 and wireless device (D) 14. However, this network path may include only two ZigBee™ nodes, for example, the wireless device (A) 11 and wireless device (B) 12.

In the process for establishing the network path, the wireless device (A) 11, wireless device (B) 12, wireless device (C) 13 and wireless device (D) 14 execute discovery processes for discovering wireless LAN nodes existing in their nearby areas. In the discovery process, each of the wireless device (A) 11, wireless device (B) 12, wireless device (C) 13 and wireless device (D) 14, that is, each ZigBee™ node, executes a process of inquiring of one or more wireless LAN nodes, which are present in its own nearby area, about channels (use channels) which are being used by them, and obtains information (table) indicative of one or more wireless LAN channels which are being used in the nearby area.

For example, each ZigBee™ node wirelessly transmits a discovery request. In this case, the discovery request may be broadcast to all wireless LAN nodes in the nearby area. The wireless transmission of the discovery request may be executed by using, for example, the wireless communication scheme of ZigBee™. For the transmission of the discovery request, use may be made of a free channel among plural ZigBee™ channels which are allocated to the 2.4 GHz band. A wireless LAN node, which is present in the nearby area of the ZigBee™ node, can receive this discovery request. The wireless LAN node, which has received the discovery request, returns a response to the ZigBee™ node which transmitted this discovery request. This response includes information indicative of the wireless LAN channel which is currently being used by this wireless LAN node. The return of the response may also be executed by using a free channel among plural ZigBee™ channels which are allocated to the 2.4 GHz band.

If each ZigBee™ node may include both a transmitter corresponding to the 2.4 GHz band and a transmitter corresponding to a 915 MHz band, use may be made of a specific ZigBee™ channel which is assigned to the 915 MHz band for the transmission of the discovery request and/or the return of the response.

Each ZigBee™ node receives a response from each nearby wireless LAN node, and generates, based on this response, information (table) indicative of one or more wireless LAN channels which are being used in the nearby area of this ZigBee™ node.

The wireless LAN node, which has received the discovery request, may temporarily stop the wireless communication of wireless LAN. In this case, the discovery request may function as a communication stop request. To temporarily stop the wireless communication of wireless LAN can prevent the communication between ZigBee™ nodes, which are in the course of the network path establishing process, from being affected by the nearby wireless LAN channels. Further, the wireless LAN node may resume the wireless communication of wireless LAN, when a permission signal has been received from the ZigBee™ node.

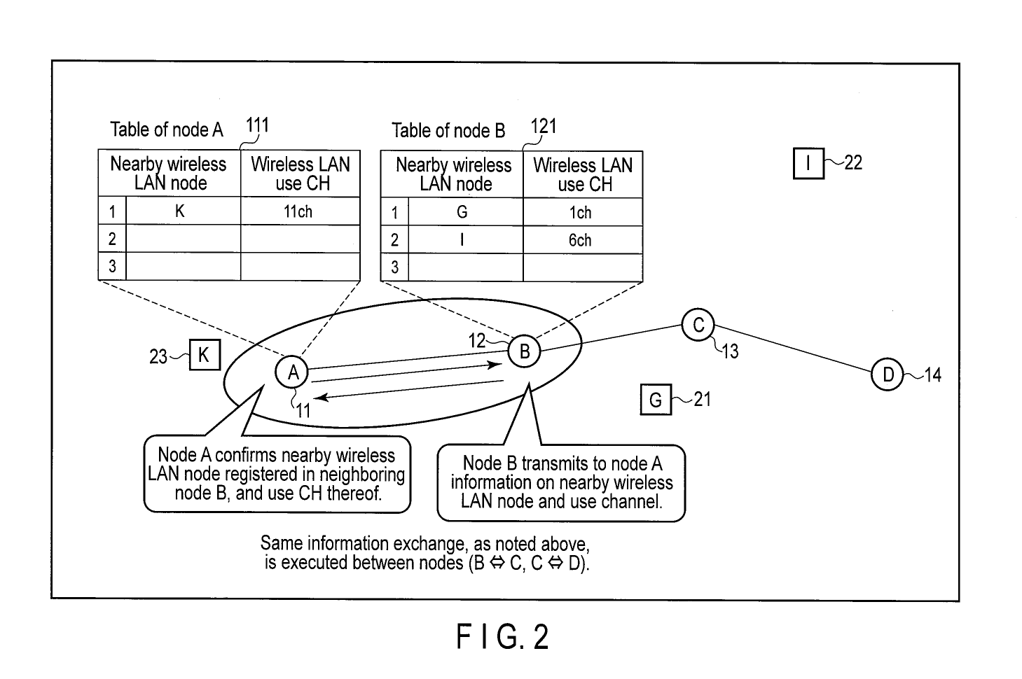

FIG. 2 illustrates an information exchange process which is executed between two mutually neighboring ZigBee™ nodes.

In FIG. 2, the wireless LAN node (G) 21 exists in the nearby area of the wireless device (B) 12, wireless device (C) 13 and wireless device (D) 14. In addition, the wireless LAN node (K) 23 exists in the nearby area of the wireless device (A) 11. Furthermore, the wireless LAN node (I) 22 may exist in the nearby area of the wireless device (B) 12, wireless device (C) 13 and wireless device (D) 14.

The wireless device (B) 12 can receive responses from the wireless LAN node (G) 21 and wireless LAN node (I) 22, respectively. Based on these responses, the wireless device (B) 12 generates a table 121. The table 121 indicates IDs of wireless LAN nodes existing in the nearby area of the wireless device (B) 12, and wireless LAN channels (wireless LAN use channels) which are being used by these wireless LAN nodes. For example, if the wireless LAN node (G) 21 is using a 1 channel (1CH) of wireless LAN, 1CH is registered as the wireless LAN use channel in the table 121, shown in FIG. 2. In addition, if the wireless LAN node (I) 22 exists in the nearby area of the wireless device (B) 12, and if this wireless LAN node (I) 22 is using a 6 channel (6CH), 6CH is also registered as the wireless LAN use channel in the table 121, shown in FIG. 2.

The wireless device (A) 11 can receive a response from the wireless LAN node (K) 23. Based on this response, the wireless device (A) 11 generates a table 111. The table 111 indicates an ID of a wireless LAN node existing in the nearby area of the wireless device (A) 11, and a wireless LAN channel (wireless LAN use channel) which is being used by this wireless LAN node. For example, if the wireless LAN node (K) 23 is using an 11 channel (11CH) of wireless LAN, 11CH is registered as the wireless LAN use channel in the table 111, shown in FIG. 2.

Two mutually neighboring ZigBee™ nodes communicate with each other by using, for example, a predetermined ZigBee™ channel, in order to execute a negotiation for determining a ZigBee™ channel which is to be used in a network path. Specifically, the two mutually neighboring ZigBee™ nodes exchange their tables, and select a ZigBee™ channel which does not overlap a frequency range which is being used by nearby wireless LANs.

A description will now be given of a process for determining a channel which is to be used for transmission of data from the wireless device (A) 11 to the wireless device (B) 12 which is the neighboring wireless device of this wireless device (A) 11.

For example, the wireless device (A) 11 receives the table 121 from the wireless device (B) 12, and confirms the wireless LAN channels which are being used in the nearby area of the wireless device (B) 12. Then, the wireless device (A) 11 selects, as a transmission channel, a ZigBee™ channel which does not overlap the frequency range of wireless LAN channels which are being used in the nearby area of the wireless device (B) 12. In the nearby area of the wireless device (B) 12 which is a reception-side device, 1CH of wireless LAN and 6CH of wireless LAN are being used. Thus, a ZigBee™ channel, which is allocated to a predetermined frequency range that overlaps neither of the two frequency ranges of the 1CH and 6CH, is selected. Then, the channel, which is to be used for transmission of data from the wireless device (A) 11 to the wireless device (B) 12, is set to be this selected ZigBee™ channel.

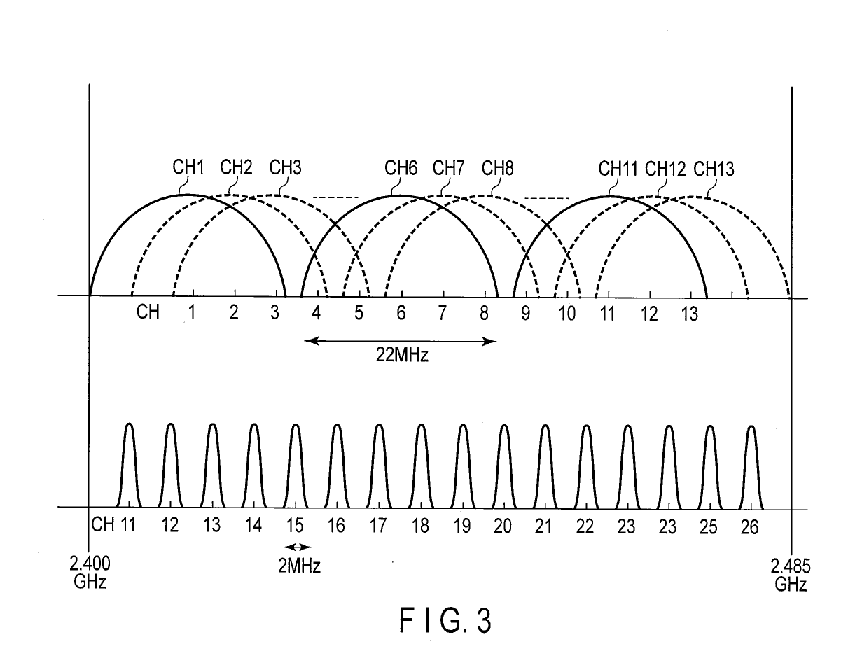

FIG. 3 illustrates a relationship between channel allocation, which is used in ZigBee™ of the 2.4 GHz band, and channel allocation which is used in wireless LAN of the 2.4 GHz band.

An upper part of FIG. 3 shows the channel allocation of wireless LAN, and a lower part of FIG. 3 shows the channel allocation of ZigBee™. The frequency range of each channel of wireless LAN is 22 MHz. On the other hand, the frequency range of each channel of ZigBee™ is 2 MHz.

When 1CH and 6CH of wireless LAN are being used in the vicinity of the wireless device (B) 12, a ZigBee™ channel, which overlaps neither of the two frequency ranges corresponding to the 1CH and 6CH, for example, 15CH of ZigBee™ or any one of 20CH to 26CH of ZigBee™ is determined to be the ZigBee™ channel which is to be used for transmission of data from the wireless device (A) 11 to the wireless device (B) 12.

In this manner, the ZigBee™ channel, which is to be used for transmission of data from the wireless device (A) 11 to the wireless device (B) 12, is determined based on wireless LAN channels which are being used in the nearby area of the wireless device (B) 12 that is the reception-side device, that is, based on the table 121 which is generated by the discovery executed by the wireless device (B) 12.

Referring back to FIG. 2, a description is given of a process for determining a ZigBee™ channel which is to be used for transmission of data from the wireless device (B) 12 to the wireless device (A) 11.

For example, the wireless device (B) 12 receives the table 111 from the wireless device (A) 11, and confirms the wireless LAN channel which is being used in the nearby area of the wireless device (A) 11. Then, the wireless device (B) 12 selects, as a transmission channel, a ZigBee™ channel which does not overlap the frequency range corresponding to the wireless LAN channel which is being used in the nearby area of the wireless device (A) 11. In the nearby area of the wireless device (A) 11 which is a reception-side device, 11CH of wireless LAN is being used. Thus, a ZigBee™ channel, which is allocated to a frequency range that does not overlap the frequency range of the 11CH, is selected as the transmission channel. Then, the channel, which is to be used for transmission of data from the wireless device (B) 12 to the wireless device (A) 11, is set to be this selected ZigBee™ channel.

In this manner, the channel, which is to be used for transmission of data from the wireless device (B) 12 to the wireless device (A) 11, is determined based on wireless LAN channels which are being used in the nearby area of the wireless device (A) 11 that is the reception-side device, that is, based on the table 111 which is generated by the discovery executed by the wireless device (A) 11.

The wireless device (B) 12 and wireless device (C) 13, too, exchange their tables, and determine the channel which is to be used for data transmission from the wireless device (B) 12 to the wireless device (C) 13, and the channel which is to be used for data transmission from the wireless device (C) 13 to the wireless device (B) 12.

The wireless device (C) 13 and wireless device (D) 14, too, exchange their tables, and determine the channel which is to be used for data transmission from the wireless device (C) 13 to the wireless device (D) 14, and the channel which is to be used for data transmission from the wireless device (D) 14 to the wireless device (C) 13.

The wireless device (A) 11 and wireless LAN node (K) 23, too, may exchange their tables, and may determine the channel which is to be used for data transmission from the wireless device (A) 11 to the wireless LAN node (K) 23, and the channel which is to be used for data transmission from the wireless LAN node (K) 23 to the wireless device (A) 11.

The reason for this is that when the wireless LAN node (K) 23 has a ZigBee™ wireless communication function, a network path between the wireless device (A) 11 and wireless LAN node (K) 23 can also be established. When the ZigBee™ in the wireless LAN node (K) 23 communicates with the wireless device (A) 11 by using the ZigBee™ wireless communication function, the wireless LAN communication function of the wireless LAN node (K) 23 may be configured to be stopped. However, it is possible that there is another wireless LAN node in the vicinity of the wireless LAN node (K) 23. Thus, also in the case of establishing the network path between the wireless device (A) 11 and wireless LAN node (K) 23, it is effective to determine the optimal channel by the above-described table exchange.

Similarly, the wireless device (B) 12 and wireless LAN node (G) 21 may exchange their tables, and may determine the channel which is to be used for data transmission from the wireless device (B) 12 to the wireless LAN node (G) 21, and the channel which is to be used for data transmission from the wireless LAN node (G) 21 to the wireless device (B) 12.

Similarly, the wireless device (C) 13 and wireless LAN node (G) 21 may exchange their tables, and may determine the channel which is to be used for data transmission from the wireless device (C) 13 to the wireless LAN node (G) 21, and the channel which is to be used for data transmission from the wireless LAN node (G) 21 to the wireless device (C) 13.

Similarly, the wireless device (D) 14 and wireless LAN node (G) 21 may exchange their tables, and may determine the channel which is to be used for data transmission from the wireless device (D) 14 to the wireless LAN node (G) 21, and the channel which is to be used for data transmission from the wireless LAN node (G) 21 to the wireless device (D) 14.

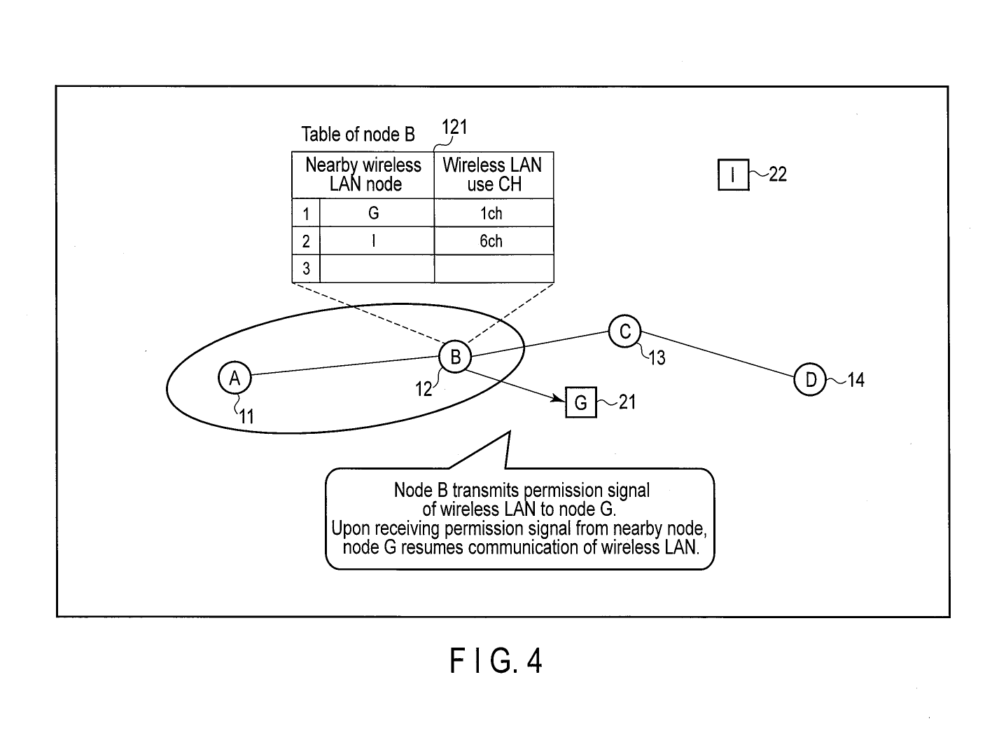

FIG. 4 illustrates a permission signal transmission process which is executed by each ZigBee™ node.

After a network path has been established, the wireless device (B) 12 wirelessly transmits a permission signal to each wireless LAN node which was discovered by itself. The permission signal is a signal for permitting the wireless LAN node to resume wireless LAN communication. Since the wireless device (B) 12 discovered the wireless LAN node (G) 21 and wireless LAN node (I) 22, the wireless device (B) 12 wirelessly transmits a permission signal to each of the wireless LAN node (G) 21 and wireless LAN node (I) 22. On the other hand, since the wireless device (A) 11 discovered the wireless LAN node (K) 23, the wireless device (A) 11 wirelessly transmits a permission signal to the wireless LAN node (K) 23.

Each of the wireless device (C) 13 and wireless device (D) 14 wirelessly transmits a permission signal to each wireless LAN node which was discovered by itself. The wireless LAN node (G) 21 may resume wireless LAN communication, on the condition that the wireless LAN node (G) 21 has received, for example, permission signals from all of the wireless device (B) 12, wireless device (C) 13 and wireless device (D) 14.

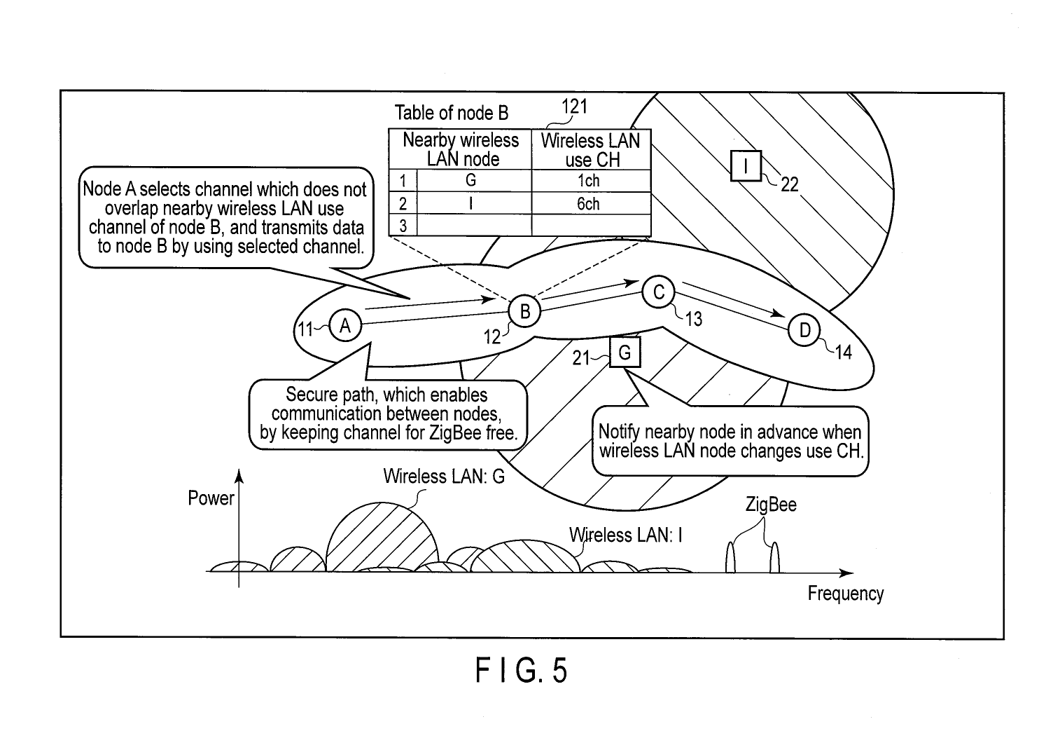

FIG. 5 illustrates an example of a data transmission process which is executed by a wireless system of ZigBee™ after a network path is established.

In FIG. 5, the case is assumed that data is transmitted from the wireless device (A) 11 to the wireless device (D) 14. The wireless device (A) 11 wirelessly transmits data to the wireless device (B) 12 by using a ZigBee™ channel which does not overlap wireless LAN channels that are being used in the vicinity of the wireless device (B) 12. The wireless device (B) 12 wirelessly transmits the data, which has been received from the wireless device (A) 11, to the wireless device (C) 13 by using a ZigBee™ channel which does not overlap wireless LAN channels that are being used in the vicinity of the wireless device (C) 13. The wireless device (C) 13 wirelessly transmits the data, which has been received from the wireless device (B) 12, to the wireless device (D) 14 by using a ZigBee™ channel which does not overlap wireless LAN channels that are being used in the vicinity of the wireless device (D) 14.

When the wireless device (B) 12 transmits data to the wireless device (A) 11, the wireless device (B) 12 wirelessly transmits data to the wireless device (A) 11 by using a ZigBee™ channel which does not overlap wireless LAN channels that are being used in the vicinity of the wireless device (A) 11.

Further, when it has become necessary to change a use channel of wireless LAN, each wireless LAN node may notify in advance a nearby ZigBee™ that the use channel is to be changed. Thereby, the wireless system of ZigBee™ can change the ZigBee™ channel, which is being used, to a ZigBee™ channel which does not overlap the wireless LAN channel after the change. Alternatively, the wireless system of ZigBee™ may prohibit a nearby wireless LAN node from changing the use channel.

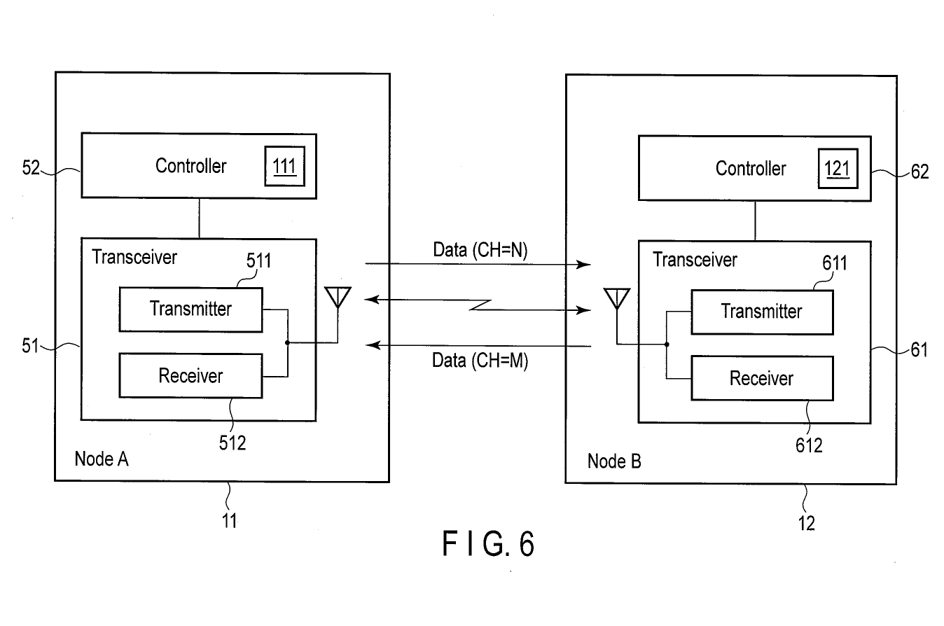

FIG. 6 illustrates a structure example of each node used in the wireless system of ZigBee™.

The wireless device (A) 11 includes a transceiver 51 and a controller 52. The transceiver 51 is configured to wirelessly transmit and receive a signal. The transceiver 51 includes a transmitter 511 configured to wirelessly transmit a signal, and a receiver 512 configured to wirelessly receive a signal. The wireless device (B) 12 includes a transceiver 61 and a controller 62. The transceiver 61 is configured to wirelessly transmit and receive a signal. The transceiver 61 includes a transmitter 611 configured to wirelessly transmit a signal, and a receiver 612 configured to wirelessly receive a signal.

The controller 52 of the wireless device (A) 11 controls the transceiver 51, and sets a channel, which is to be used for transmission of data from the transceiver 51 to the wireless device (B) 12, to be a first channel (ZigBee™ channel CH=N). The first channel is determined in accordance with the information (table 121) indicative of one or more wireless LAN channels (e.g. 1CH, 6CH) which are being used in the nearby area of the wireless device (B) 12. The first channel is a ZigBee™ channel which does not overlap the frequency range corresponding to the wireless LAN channels (1CH, 6CH).

On the other hand, the controller 62 of the wireless device (B) 12 sets the channel, which is to be used for the transceiver 61 to receive data from the wireless device (A) 11, to be the first channel.

In the process for determining the first channel, the controller 52 of the wireless device (A) 11 may receive from the wireless device (B) 12 the table 121 which has been generated by the controller 62, and the controller 52 may determine, based on the table 121, the channel, which is to be used for transmission of data from the transceiver 51 to the wireless device (B) 12, to be the first channel.

Alternatively, based on the table 121, the controller 62 of the wireless device (B) 12 may determine the channel which is to be used for transmission of data from the wireless device (A) 11 to the wireless device (B) 12, that is, the channel which is to be used for the transceiver 61 to receive data from the wireless device (A) 11, to be the first channel.

Furthermore, the controller 52 executes a discovery process. Specifically, the controller 52 inquires of one or more wireless LAN nodes, which are present in the nearby area of the wireless device (A) 11, about use channels, and obtains information (table 111) indicative of one or more wireless LAN channels which are being used in the nearby area of the wireless device (A) 11.

The controller 62 of the wireless device (B) 12 controls the transceiver 61, and sets a channel, which is to be used for transmission of data from the transceiver 61 to the wireless device (A) 11, to be a second channel (ZigBee™ channel CH=M). The second channel is determined in accordance with the information (table 111) indicative of one or more wireless LAN channels (e.g. 11CH) which are being used in the nearby area of the wireless device (A) 11. The second channel is a ZigBee™ channel which does not overlap the frequency range corresponding to the wireless LAN channel (11CH).

In this case, the controller 62 may receive the table 111 from the wireless device (A) 11, and the controller 62 may determine, with use of the table 111, the channel which is to be used for transmission of data from the transceiver 61 to the wireless device (A) 11.

Alternatively, based on the table 111, the controller 52 of the wireless device (A) 11 may determine the channel which is to be used for transmission of data from the wireless device (B) 12 to the wireless device (A) 11, that is, the channel which is to be used for the transceiver 51 to receive data from the wireless device (B) 12, to be the second channel.

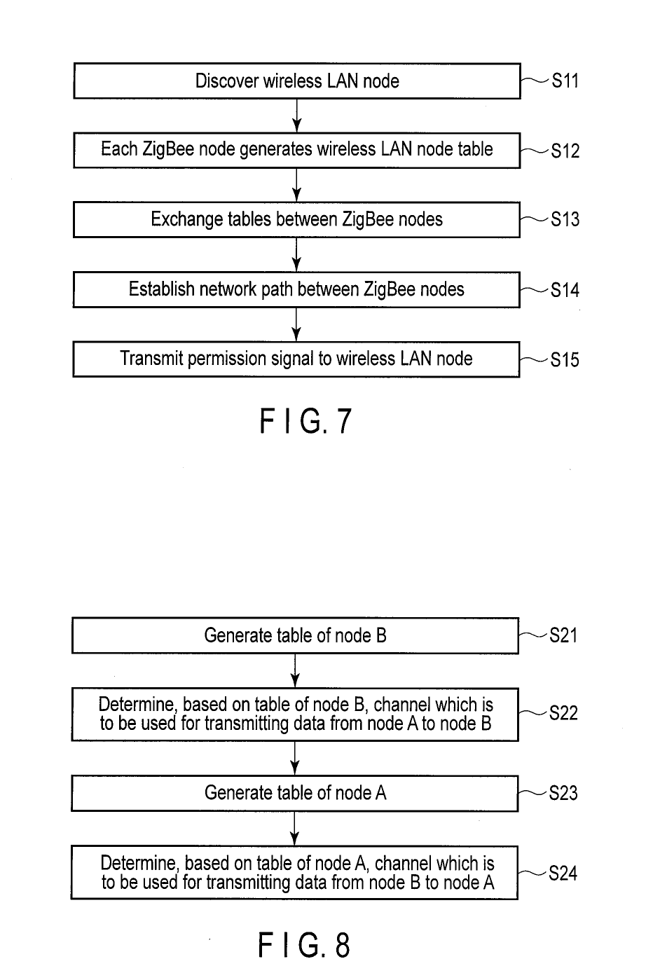

A flowchart of FIG. 7 illustrates the outline of an operational procedure of the ZigBee™ wireless system of the present embodiment.

In a process for establishing a network path of the ZigBee™ wireless system, each ZigBee™ node executes, to start with, a discovery process for discovering wireless LAN nodes existing in its own nearby area (step S11). In this discovery process, each ZigBee™ node wirelessly transmits a discovery request to each wireless LAN node existing in its own nearby area, and inquires of each wireless LAN node, which exists in its own nearby area, about use channels. Then, each ZigBee™ node wirelessly receives, from each wireless LAN node existing in its own nearby area, a response indicative of a channel which is being used by each wireless LAN node.

Each ZigBee™ node generates the above-described table (wireless LAN node table) by using the received response (step S12). Two mutually neighboring ZigBee™ nodes exchange the tables (step S13). Based on the contents of the tables, the two mutually neighboring ZigBee™ nodes determine a ZigBee™ channel which does not overlap wireless LAN channels that are being used in the nearby area of the reception node, and establishes a network path between the ZigBee™ nodes (step S14). The ZigBee™ channel, which is used for transmitting data to the reception node, is set to be the determined channel. Then, each ZigBee™ node wirelessly transmits the above-described permission signal to each wireless node existing in its own nearby area (step S15).

A flowchart of FIG. 8 illustrates a channel determination procedure for determining channels which are to be used for data transmission and reception.

The channel determination procedure is described by illustrating the wireless device (A) 11, which is a ZigBee™ node A, and the wireless device (B) 12, which is a ZigBee™ node B, by way of example.

The wireless device (B) 12 inquires of one or more wireless LAN nodes, which exist in the nearby area of the wireless device (B) 12, about use channels. Then, based on the inquiry result (discovery result), the wireless device (B) 12 generates the table 121 indicative of one or more wireless LAN channels which are being used in the nearby area of the wireless device (B) 12 (step S21).

The wireless device (A) 11 receives the table 121 from the wireless device (B) 12. Then, the wireless device (A) 11 determines, based on the table 121, the channel which is to be used for transmitting data from the wireless device (A) 11 to the wireless device (B) 12 (step S22). The wireless device (A) 11 notifies the wireless device (B) 12 of the determined channel.

Alternatively, the channel, which is to be used for transmitting data from the wireless device (A) 11 to the wireless device (B) 12, may be determined by the wireless device (B) 12. In this case, the determined channel is notified from the wireless device (B) 12 to the wireless device (A) 11.

In the above-described step S22, a ZigBee™ channel, which does not overlap the wireless LAN channels existing in the nearby area of the wireless device (B) 12, is selected, and the channel, which is to be used for transmitting data from the wireless device (A) 11 to the wireless device (B) 12, is set to be this selected channel.

The wireless device (A) 11, too, inquires of one or more wireless LAN nodes, which exist in the nearby area of the wireless device (A) 11, about use channels. Then, based on the inquiry result (discovery result), the wireless device (A) 11 generates the table 111 indicative of one or more wireless LAN channels which are being used in the nearby area of the wireless device (A) 11 (step S23).

The wireless device (B) 12 receives the table 111 from the wireless device (A) 11. Then, the wireless device (B) 12 determines, based on the table 111, the channel which is to be used for transmitting data from the wireless device (B) 12 to the wireless device (A) 11 (step S24). The wireless device (B) 12 notifies the wireless device (A) 11 of the determined channel.

Alternatively, the channel, which is to be used for transmitting data from the wireless device (B) 12 to the wireless device (A) 11, may be determined by the wireless device (A) 11. In this case, the determined channel is notified from the wireless device (A) 11 to the wireless device (B) 12.

In the above-described step S24, a ZigBee™ channel, which does not overlap the wireless LAN channels existing in the nearby area of the wireless device (A) 11, is selected, and the channel, which is to be used for transmitting data from the wireless device (B) 12 to the wireless device (A) 11, is set to be this selected channel.

As has been described above, in the present embodiment, by inquiring of one or more wireless LAN nodes, which are present in the nearby area of a neighboring wireless device, about use channels, the first information indicative of one or more wireless LAN channels which are being used in the nearby area of the neighboring wireless device is obtained in advance. Then, the channel, which is to be used for wirelessly transmitting data from a first wireless device to the neighboring wireless device of this first wireless device, is set to be a channel which does not overlap one or more wireless LAN channels that are being used in the nearby area of the neighboring wireless device.

Thus, since it is possible to establish a network path using the channel which does not overlap the wireless LAN channels that are being used in the nearby area of the neighboring wireless device, the occurrence of co-channel interference can be suppressed.

In the above description, the case is assumed that the wireless communication scheme corresponding to the wireless system of the embodiment is ZigBee™, and another wireless system, which may possibly interfere with the wireless system of the embodiment, is wireless LAN. However, the structure of the embodiment is applicable in order to prevent interference between two arbitrary kinds of wireless systems which use the same frequency band.

Moreover, in the above description, the case in which the discovery process is executed by using the wireless communication scheme of ZigBee™ has been described by way of example. However, for example, if each ZigBee™ node is configured to support the wireless communication scheme of wireless LAN, the discovery process can be executed by using the wireless communication scheme of wireless LAN.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A wireless device configured to execute wireless communication according to a first wireless communication scheme, comprising:
a transceiver configured to wirelessly transmit and receive a signal; and
a controller configured to set a channel of the first wireless communication scheme, which is to be used for transmission of data from the transceiver to a neighboring wireless device of the wireless device, to be a first channel, the first channel being determined in accordance with first information indicative of one or more channels of another wireless communication scheme which are being used in a nearby area of the neighboring wireless device, and the first channel not overlapping a frequency range corresponding to the one or more channels,
wherein the first information is obtained by a process of inquiring one or more first nodes of the another wireless communication scheme, which are present in the nearby area of the neighboring wireless device, about use channels, the process of inquiring being executed by the neighboring wireless device.

2. The wireless device of claim 1, wherein:
the controller is configured to inquire of one or more second nodes of the another wireless communication scheme, which are present in the nearby area of the wireless device, about use channels, thereby obtaining second information indicative of one or more channels of the another wireless communication scheme which are being used in the nearby area of the wireless device;
a channel of the first wireless communication scheme, which is to be used for transmitting data from the neighboring wireless device to the wireless device, is set to be a second channel in accordance with the second information; and
the second channel does not overlap a frequency range corresponding to the one or more channels of the another wireless communication scheme which are being used in the nearby area of the wireless device.

3. The wireless device of claim 1, wherein:
each of the one or more first nodes is configured to support both the another wireless communication scheme and the first wireless communication scheme; and
the process of inquiring includes a process of executing communication with each of the first nodes by using the first wireless communication scheme.

4. The wireless device of claim 1, wherein the process of inquiring includes:
a process of wirelessly transmitting a discovery request to the one or more first nodes; and
a process of wirelessly receiving, from each of the one or more first nodes, a response indicative of a channel which is being used by each of the first nodes.

5. The wireless device of claim 1, wherein the first wireless communication scheme and the another wireless communication scheme use the same frequency band.

6. The wireless device of claim 5, wherein the frequency band is an ISM band.

7. A wireless device configured to execute wireless communication according to a first wireless communication scheme, comprising:
a transceiver configured to wirelessly transmit and receive a signal; and
a controller configured to inquire one or more first nodes of another wireless communication scheme, which are present in a nearby area of the wireless device, about use channels, thereby obtaining first information indicative of one or more channels of the another wireless communication scheme which are being used in the nearby area of the wireless device, and to set a channel of the first wireless communication scheme, which is to be used for the transceiver to receive data from a neighboring wireless device of the wireless device, to be a first channel,
wherein the first channel is determined in accordance with the first information, the first channel not overlapping a frequency range corresponding to the one or more channels.

8. The wireless device of claim 7, wherein:
the controller is configured to set a channel of the first wireless communication scheme, which is to be used for transmitting data from the transceiver to the neighboring wireless device, to be a second channel;
the second channel is determined in accordance with second information indicative of one or more channels of the another wireless communication scheme which are being used in the nearby area of the neighboring wireless device, the second channel not overlapping a frequency range corresponding to the one or more channels indicated by the second information; and
the second information is obtained by a process of inquiring one or more second nodes of the another wireless communication scheme, which are present in the nearby area of the neighboring wireless device, about use channels, the process of inquiring being executed by the neighboring wireless device.

9. The wireless device of claim 7, wherein the first wireless communication scheme and the another wireless communication scheme use the same frequency band.

10. A method for controlling wireless communication between a wireless device and a neighboring wireless device of the wireless device, the wireless communication being executed according to a first wireless communication scheme, the method comprising:
inquiring one or more first nodes of another wireless communication scheme, which are present in a nearby area of the neighboring wireless device, about use channels, thereby obtaining first information indicative of one or more channels of the another wireless communication scheme which are being used in the nearby area of the neighboring wireless device; and
setting, based on the first information, a channel of the first wireless communication scheme, which is to be used for transmitting data from the wireless device to the neighboring wireless device of the wireless device, to be a first channel which does not overlap a frequency range corresponding to the one or more channels.

11. The method of claim 10, further comprising:
inquiring of one or more second nodes of the another wireless communication scheme, which are present in the nearby area of the wireless device, about use channels, thereby obtaining second information indicative of one or more channels of the another wireless communication scheme which are being used in the nearby area of the wireless device; and
setting, based on the second information, a channel of the first wireless communication scheme, which is to be used for transmitting data from the neighboring wireless device to the wireless device, to be a second channel which does not overlap a frequency range corresponding to the one or more channels of the another wireless communication scheme which are being used in the nearby area of the wireless device.

12. The method of claim 10, wherein:
each of the one or more first nodes is configured to support both the another wireless communication scheme and the first wireless communication scheme; and
the inquiring includes executing communication with each of the first nodes by using the first wireless communication scheme.

13. The method of claim 10, wherein the inquiring includes:
wirelessly transmitting a discovery request to the one or more first nodes; and
wirelessly receiving, from each of the one or more first nodes, a response indicative of a channel which is being used by each of the first nodes.

14. The method of claim 10, wherein the first wireless communication scheme and the another wireless communication scheme use the same frequency band.

15. The method of claim 14, wherein the frequency band is an ISM band.
